(19) United States
(12) Patent Application Publication
(10) Pub. No.: US 2003/0023517 A1
(43) Pub. Date: Jan. 30, 2003

(54) System and method for managing historical information on an object on an electronic tag

(76) Inventors: Gary F. Marsh, Santa Clarita, CA (US); Ben R. Ezzell, Guerneville, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/165,775

(22) Filed: Jun. 7, 2002

Related U.S. Application Data
(60) Provisional application No. 60/297,085, filed on Jun. 8, 2001.
(60) Provisional application No. 60/322,380, filed on Sep. 13, 2001.

(51) Int. Cl. G06F 7/00; G06F 17/60

(52) U.S. Cl. 705/28; 707/10

(57) ABSTRACT

A distributed database system and associated methods maintain historical data regarding an entity, such as a person or an object, in a tag or other object in association with the entity. The data proper is maintained with the entity and the data rules used to interpret the data proper are maintained at a separate location. The data proper maintained with the entity is stored in a manner to reduce the amount of memory space required. The data proper maintained with the entity is effectively encrypted from parties that do not have access to the data rules. The data proper may be converted to a fixed form, such as a bar code label, and attached to the entity to permit historical information to be ascertained at a later time.

### REFERENCE TO RELATED APPLICATION

The present application claims priority under 35 U.S.C. §119(e) from U.S. Provisional Application No. 60/297,085 filed Jun. 8, 2001, entitled “SYSTEM AND METHOD FOR RECORDING TRANSACTION HISTORIES ON AN ELECTRONIC IDENTIFICATION TAG,” and U.S. Provisional Application No. 60/322,380 filed Sep. 13, 2001, entitled “SYSTEM AND METHOD FOR RECORDING TRANSACTION HISTORIES ON AN ELECTRONIC IDENTIFICATION TAG,” which are incorporated herein by reference.

### BACKGROUND OF THE INVENTION

1. Field of the Invention

The present invention relates in general to systems and methods for distributed data management, and in particular, to systems and methods for managing historical information regarding an object or a person.

2. Description of the Related Art

In recent years, the availability of databases and of computer networks has given rise to a new technology called distributed databases. A distributed database is generally an integrated database which is built on top of a computer network rather than on a single computer. The data which constitute the database is stored at the different sites of the computer network, and the application programs which are run by the computers access data at different sites. Databases may involve different database management systems, running on different architectures, that distributes the execution of transactions.

Generally, a database contains both data (data proper) and data rules. Data proper is the raw information and the data rules are rules which make sense of the raw information. The data proper and data rules are usually kept in the same location.

There are some disadvantages to distributed database system. For example, if a database server becomes inoperative, data cannot be accessed by the user computers. Moreover, even if the database server is operative, but a user computer loses access or connection to the database server, data cannot be accessed by the user computer. Generally, in distributed database systems, the data and the object referred to by the data remain physically separate and disconnected. The separation usually necessitates some means of identifying the referenced object and providing a key or cross-reference to the relevant data. This discontinuity between the data and the object referenced has several disadvantages. First, the a cross-reference or identifier must be maintained. Second, potential errors could arise when cross-reference identifiers are copied from the object and subsequently entered elsewhere to access the data. Third, the system is ineffective where there is limited access to the central or distributed database, or if unreliable channels of communication are used to receive information from remote sources.

### SUMMARY OF THE INVENTION

The present invention relates to systems and methods for managing historical information regarding an object or a person.

An aspect of the invention is a distributed database system for tracking historical information about an entity. The distributed database system comprises a processing system that includes data rules for processing received data, a data tag associated with the entity, the data tag storing historical data regarding the entity, the historical data stored on the data tag as variable field length encoded data in a plurality of data fields, and a communication system for transferring the variable field length encoded data between the processing system and the data tag, the processing system receiving the variable field length encoded data from the data tag and decoding the data to retrieve the historical data encoded on the data tag. The database system further comprises the processing system wherein the processing system revises the historical data and encodes the revised historical data into variable field length encoded data that is transferred to the data tag on the entity. The database system further comprises the data wherein the data in at least one of the plurality of data fields determines a field length of at least one other of the plurality of data fields. The database system further comprises an entity wherein the entity comprises an animal, and wherein the data tag is attached to the animal, the data tag comprising a storage device for storing the variable field length encoded data and a transceiver coupled to the storage device. The database system further comprises a communication system wherein the communication system includes a transceiver that communicates with the transceiver of the data tag to transfer historical data between the data tag and the processing system. The database system further comprises the entity wherein the entity is a product. The database system further comprises the product wherein the product is one of a plurality of products, each product in the plurality of products having a respective data tag so that each product can be distinguished by historical data stored on the respective data tag of the product.

Another aspect of the invention is a method of tracking historical information about an entity. The method of tracking historical information comprises storing the historical information as variable field length encoded data on a data tag associated with the entity, reading the variable field length encoded data and decoding the variable field length encoded data to reproduce the historical data, updating the historical data to include additional information about the entity, and storing the updated historical data as variable field length encoded data on the data tag associated with the entity. The method of tracking historical information further comprises converting the variable field length encoded data on the tag to a fixed form representation of the historical information for permanent association with at least a portion of the entity. The entity comprises a cow and a portion of the entity comprises a beef product of the cow. The fixed form representation of the historical information comprises a label having visible indicia. The visible indicia comprises a bar code. The visible indicia further comprises a two-dimensional bar code.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

The present invention is described in more detail below in connection with the attached drawings, which are meant to illustrate and not limit the invention, and in which:

FIG. 1 illustrates a block diagram of a distributed database system, according to aspects of an embodiment of the invention;

FIG. 2 illustrates a block diagram of a distributed database system, according to aspects of a particular embodiment of the invention;

FIG. 3 illustrates a block diagram of a physical division of data proper and data rules within a distributed database system, according to aspects of an embodiment of the invention;

FIG. 4 illustrates a process diagram of data tag conversion during product processing, according to aspects of a particular embodiment of the invention;

FIG. 5a illustrates an exemplary expanded view of data stored on a data tag, according to aspects of a particular embodiment of the invention; and

FIG. 5b illustrates another exemplary expanded view of data stored on a data tag, according to aspects of a particular embodiment of the invention;

### DETAILED DESCRIPTION OF THE PREFERRED EMBODIMENT

The present invention relates to systems and methods for managing historical information regarding an object or person with the historical information remaining with the object or person.

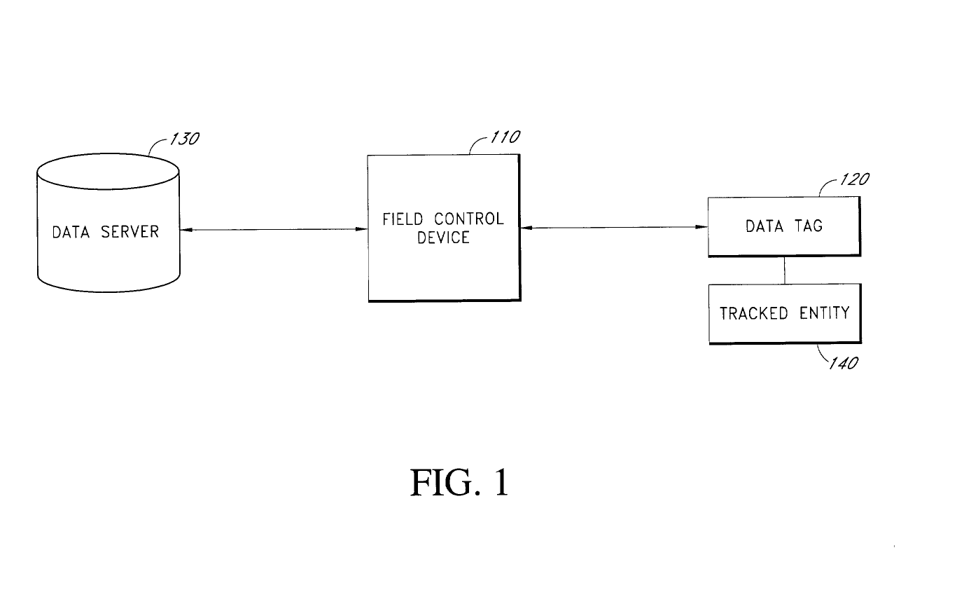

FIG. 1 illustrates a block diagram of a distributed database system 100, according to aspects of an embodiment of the invention. The distributed database system 100 includes a field control device 110 and data tag 120. In one embodiment of the invention, the distributed database system 100 further comprises a data server 130. The data tag 120 is maintained in proximity of a tracked entity 140. In one embodiment of the invention, the data tag 120 is attached to the tracked entity 140.

The field control device 110 comprises any device capable of operating a computer program and communicating data with other devices. In one embodiment of the invention, the field control device 110 comprises a computing device advantageously connected to a transmission device. For example, the computing device may comprise a hand-held computing device such as a personal digital assistant (PDA). Examples of PDA's are Palm III and Palm IV, commercially available from Palm, Inc., Compaq iPAQ Pocket PC, commercially available from Compaq Computer Corporation, and the like. The computing device comprises an operating system, such as, for example, Palm OS commercially available from Palm, Inc., or Microsoft Windows CE commercially available from Microsoft Corporation, or the like. The computing device is operationally connected to an antenna (not shown). The antenna comprises any device capable of transmitting and receiving data, such as, for example, a radio frequency (RF) antenna. In one embodiment of the invention, the computing device and the antenna are contained in one device (e.g., a PDA) capable of both executing a computer program and also communicating with other devices.

The data tag 120 comprises any device capable of storing digital data. In one embodiment of the invention, the data tag 120 comprises a radio-frequency identification (RFID) tag. For example, the data tag 120 comprises RFID tags such as Tag-it, commercially available from Texas Instruments Incorporated, I-Code smart labels, commercially available from Philips Semiconductors, microID RFID devices commercially available from Microchip Technology Inc., Performa Series RFID devices commercially available from Checkpoint Systems, and the like. In one embodiment of the invention, the data tag 120 is encased in a material or package to protect the data tag 120 from damage, such as, for example, a sealed plastic casing to protect the data tag 120 from weather-related damage. In one embodiment of the invention, the data tag 120 is encased in a flexible material or package to protect the data tag 120 from damage related to the movement or transfer of the tracked entity 140. The data server 130 comprises any device capable of executing computer programs. In one embodiment of the invention, the data server 130 comprises a personal computing device. In another embodiment of the invention, the data server 130 comprises a computer server capable of executing computer programs that collectively serve the needs of one or more computing devices.

The tracked entity 140 comprises a person, an object, or a thing. In one embodiment of the invention, the tracked entity 140 comprises a person where it is advantageous to maintain historical information about that person, such as, for example, a hospital patient, a child, an airline traveler, an employee, and the like. In one embodiment of the invention, the tracked entity 140 comprises an object where it is advantageous to maintain historical information about that object, such as, for example, livestock, a household pet, a shipping package, an automobile, and the like. In one embodiment of the invention, the tracked entity 140 comprises an object where it is advantageous to maintain historical information about the person in possession of that object, such as, for example, a credit card, a passport, an identification card, and the like. The data tag 120 is attached to or associated with the tracked entity 140 to advantageously remain with the tracked entity 140, as the tracked entity 140 changes its location. For example, if the tracked entity 140 is a hospital patient, the data tag 120 may be maintained on a plastic bracelet on the wrist of the patient. As another example, if the tracked entity 140 is a cow, the data tag 120 may be maintained in a protective housing attached to the ear of the cow. As another example, if the tracked entity 140 is a shipping package, the data tag 120 may be maintained in an adhesive package attached to the shipping package.

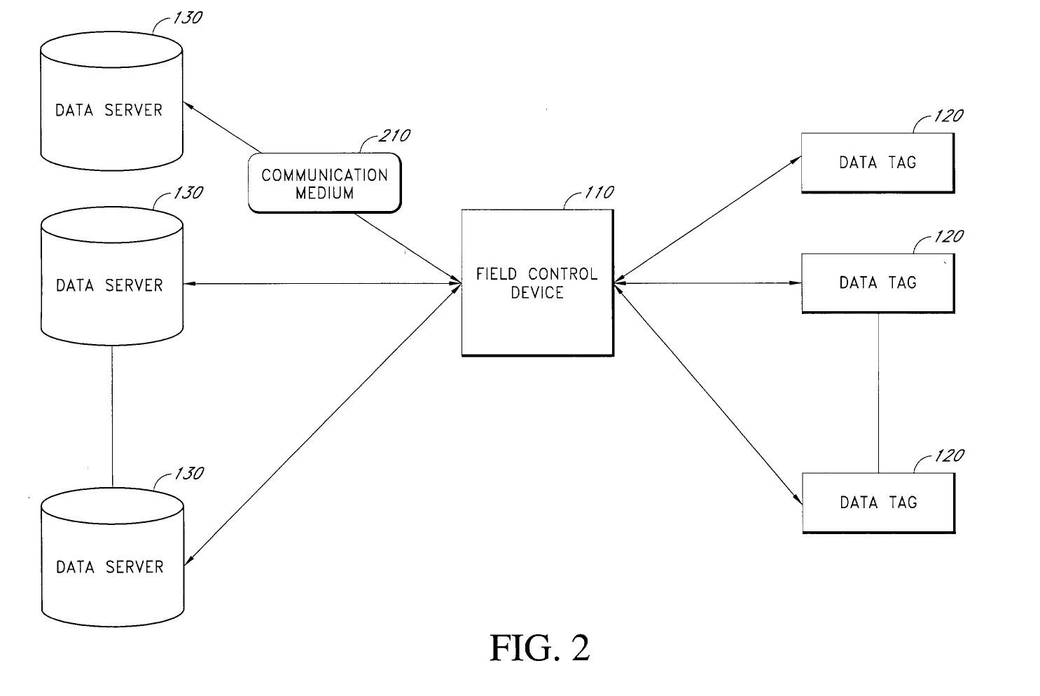

FIG. 2 illustrates a block diagram of a distributed database system 100, according to aspects of a particular embodiment of the invention. As illustrated in FIG. 2, the field control device 110 may communicate with a plurality of data tags 120 and one or more data servers 130 using various communication systems. In one embodiment of the invention, the field control device 110 communicates with the data tag 120 using a wireless communication system, such as, for example, a radio transmission operating at frequencies in the 13.56 MHz band. In one embodiment of the invention, the field control device 110 reads from and writes data to each data tag 120. In another embodiment of the invention, where it is disadvantageous to alter the data on the data tag 120, the field control device 110 only reads data from the data tag 120 and cannot write to the data tags 120.

In one embodiment of the invention, the field control device 110 communicates with at least one data server 130 using a wireless communication system, such as, for example, a radio transmission operating at frequencies in the 13.56 MHz band. In another embodiment of the invention, the field control device 110 communicates with at least one data server 130 through a communication medium 210. The communication medium 210 comprises a computer network system such as, for example, a Local Area Network (LAN), a wide area network (WAN), the Internet, a satellite communication system, or the like. In another embodiment of the invention, the field control device 110 communicates with the data server 130 through a direct connection, such as, for example, a FireWire, a Universal Serial Bus (USB), or the like.

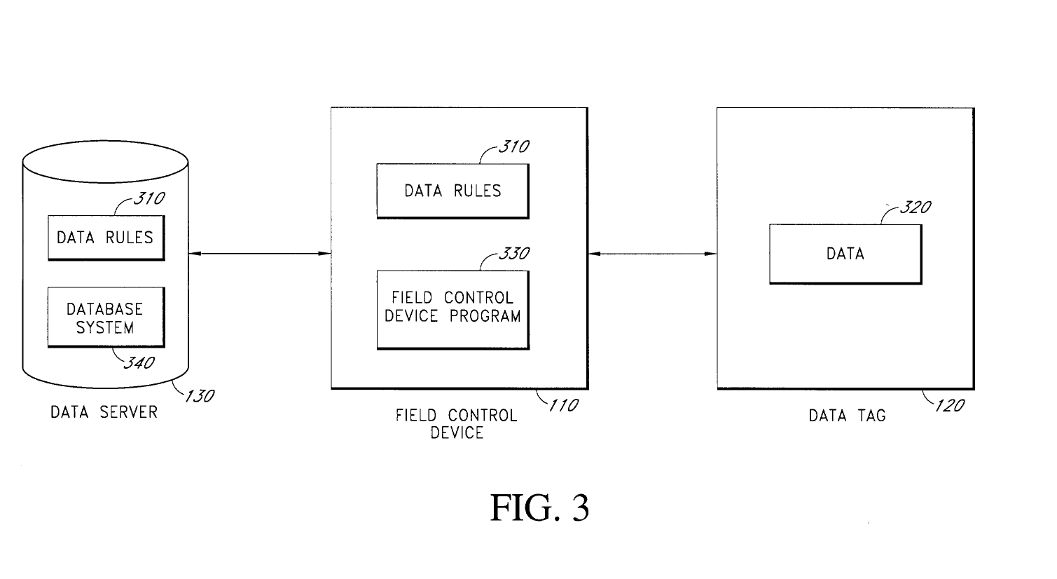

FIG. 3 illustrates a block diagram of a physical division of data proper and data rules 300 within a distributed database system, according to aspects of an embodiment of the invention. As illustrated in FIG. 3, the field control device 110 comprises data rules 310 and a field control device program 330. The data tag 120 comprises data 320. The data 320 comprises the data proper representing information relating to the tracked entity 140. The data rules 310 comprise the database schema or the data rules and references used to interpret the data 320 into meaningful information about the tracked entity 140.

In one embodiment of the invention, the data 320 advantageously contains data proper without data rules. It is advantageous to maintain the data 320 with the data tag 120 and to maintain the data rules 310 with the field control device 110. By only having the data proper reside on the data tag 120, less memory space is required, allowing for a smaller data tag 120 to be utilized. A smaller data tag 120 is advantageous in applications where the tracked entity 140 is small. Moreover, by keeping only data proper on a data tag 120, the data 320 is effectively encrypted with respect to a party who gains access to or takes possession of the tracked entity 140, but who does not have access to the data rules 310. Because the data rules 310 are needed to interpret the data 320, a party who gains access to or takes possession of the tracked entity 140, but is not in possession of the data rules 310 can not interpret the data 320 residing on the data tag 120. Therefore, in applications where it is advantageous to have data confidentiality and security, the data 320 cannot be interpreted by a party who does not have access to the data rules 310. Also, by keeping the data 320 with the tracked entity 140, as the tracked entity 140 is transferred or re-located, the data 320 remains with the tracked entity 140. The data rules 310 may be transferred separately than the tracked entity 140 through, for example, the Internet. Therefore, the information relating to tracked entity 140 can be ascertained by reading the data tag 120 on the tracked entity 140 even though the tracked entity 140 has changed locations.

The field control device program 330 comprises one or more computer programs that operate the field control device 110. The operations of the field control device program 330 comprise interacting with the data tag 120, including writing portions of the data 320 to the data tag 120, reading portions of the data 320 from the data tag 120, and verifying the portions of the data 320 written to or read from the data tag 120. Also, the operations of the field control device program 330 comprise interacting with the data server 120, including writing data to the data server 120, reading data from the data server 120, and reading the data rules 310 from the data server 120. The operations of the field control device program 330 comprise presenting a user interface to the user of the field control device 110. The user interface allows a user of the field control device 110 to access the functions of the field control device 110. For example, the field control device program 330 uses the data rules 310 to interpret the data 320 from the data tag 120 and to present the interpreted data through the user interface to the user of the field control device 110 as meaningful information regarding the tracked entity 140.

In one embodiment, open source or proprietary data encryption is utilized to prevent unauthorized access to data, or to permit some portion of the data to be accessed while restricting access to other portions. Because the data stored is heavily compacted and because encryption conceals the structure as well as the data proper, a relatively simple key encryption advantageously provides a very high degree of security. In addition, any random key used to decrypt the encrypted information may produce what appears to be validly decrypted information but without providing verification of the validity of the key or the data.

As illustrated in FIG. 3, the data server 130 comprises the data rule 310 and a database system 340. In one embodiment of the invention, the database system 340 comprises a database management system (DBMS) or a database manager, such as, for example, Microsoft Access, Microsoft SQL Server, DB2 from IBM, database management products from Oracle and Sybase, and the like. A DBMS is a computer program that enables one or more computer users to create and access data in a database. The DBMS manages user requests (and requests from other programs) so that users and other programs are free from having to understand where the data is physically located on storage media and, in a multi-user system, who else may also be accessing the data. In handling user requests, the DBMS ensures the integrity of the data (that is, assuring that the data continues to be accessible and is consistently organized as intended) and security (making sure only those with access privileges can access the data). A conventional type of DBMS includes a relational database management system (RDBMS). A conventional type of user and program interface for the DBMS is the Structured Query Language (SQL). Another example of a DBMS includes the object-oriented database management system (ODBMS). In one embodiment of the invention, the operation of the database system 340 comprises storing and maintaining the data read from one or more data tags 120 by one or more field control devices 110 and transferred to the data server 130. In one embodiment of the invention, the operation of the database system 340 comprises statistical manipulation and analysis of data received from one or more data tags 120 for presentation to one or more users of the data server 130. In one embodiment of the invention, the operation of the database system 340 comprises data mining. Generally, data mining is sorting through data. Thus, in one embodiment of the invention, the database system 340 can be advantageously used for data mining to identify patterns and establish relationships relating to one or more tracked entities 140.

As illustrated in FIG. 3, the data 320 resides on the data tag 120. In one embodiment of the invention, the data 320 is advantageously stored in a manner to reduce the required memory space on the data tag 120. The data 320 comprises data fields. Data fields represent each category of information about the tracked entity 140, such as, for example, serial number, location, owner, and the like. The data fields comprise one or more bits of data. In one embodiment of the invention, the data fields advantageously use substantially the least amount of bits required to represent the data associated with the data field.

In one embodiment, the data tag 120 comprises a data tag header. Each data tag 120 is initialized before first use. For example, the data tag 120 is initialized with three 32-bit blocks of data (i.e., 3 DWORD values) using a structure appropriate for the information stored about the tracked entity 140. For example, the data structure may include fields for hardware version number (8 bits), company name (20 bits), software version number (14 bits), software program identification number (14 bits), software program revision number (8 bits), expiration flag (2 bits), a count or date (22 bits), a date/time format (3 bits), a use hard lock flag (1 bit), a usage and access flag (i.e. in house use or for export use) (1 bit), and multiple tags field (3 bits). Therefore, the total requirement for the data structure, in this example, is 96 bits or 3 DWORDs. Each value for a field is supplied by the software on the database system 340. Although the actual values intended for storage may take several forms, such as integers or short integers, the data is restructured to fit the 96-bit structure. An example of the data restructuring methods are disclosed herein. In one embodiment of the invention, multiple data tags 120 are associated with a single tracked entity 140. As an example, if multiple data tags 120 are created (i.e., as indicated by the multiple tags field being greater than 1), the first data tag 120 initialized has the multiple tags field set to 2, with each subsequent tag in the set receiving the value 3. Alternately, if only a single data tag 120 is used, the multiple tags field is set to 1, while a value of 0 indicates a single, packed tag that cannot be expanded.

Continuing with the foregoing example, once the data tag 120 is initialized, the data tag 120 is available to be written to or read from. To write data to the data tag 120, a data record is first created. The field control device program 330 creates a record in program memory before writing the record to the data tag 120. As an example, the process of creating a record comprises initializing an empty record block, setting the fields for data size, item count, items remain, data pointer, and item count pointer to 0. Then, the program writes the 7-bit report ID to the record block, increments data size by 7, and sets data pointer to the end of the report ID. Other fields are written in a manner appropriate for writing that particular field. The field control device program 330 also comprises programs for processing data. The programs for processing data parse the data set while performing a comparison between the available space on the data tag 120 and the space required to write the data record. The data set may advantageously be split into two or more records, with each subsequent record being written to the next data tag 120 in the series of multiple data tags 120. Once the field control device program 330 has created a data record, and has processed the data, the data is written to the data tag 120 by transmitting the data from the field control device 110 to the data tag 120. In one embodiment, reading the data from the data tag 120 is the reverse process of writing to the data tag 120, with the exception that during a read, a data record is neither created or deleted on the data tag 120.

In one embodiment of the invention, numerical values, such as integers and floating point number, are advantageously stored in a minimum significant digits format. In one embodiment, integer values are stored as integers using the smallest bit-size required by the defined value range with negative integers defined by a flag bit. For example, an integer with a permitted data range of 0 to 100 requires 7 bits of storage while an integer with a permitted data range of 0 to 25 requires 5 bits of storage. Therefore, in this manner, storage space is reduced from a standard integer value storage requirement which is normally 32 bits to cover the predefined range of −2147483647 to 2147483647. For example, in an embodiment of the invention where the tracked entity is a cow, 32 bits may be used for unique animal identification (ID) to represent over 4 billion unique animals, 8 bits may be used for the cow's country code representing 256 different countries, and 22 bits may be used for the cow's ranch ID to represent over 4 million different ranches.

In one embodiment, floating point values, such as decimals and fractions, are stored as integers with the data rules 310 defining a conversion scheme from the stored integer value to the floating point value. For example, a floating point value such as 123.4, within a permitted data range of 0 to 999.99, would be stored as 12340, requiring 13 bits of data space. Therefore, in this manner, storage space is reduced from a standard floating point value storage requirement which is normally 64 bits to cover the predefined range of −0.9999999999×10¹⁹ to 0.9999999999×10²⁰.

In one embodiment, date values are stored in 12 bits, and represent the number of days elapsed since a root date. Thus, a 12-bit value advantageously represents over 11 years. For example, if Jan. 1, 2000 is used as the root date, Jan. 1, 2000 is represented by 0 and Jan. 17, 2000 is represented by 16. In this manner, the space requirement for a date value can be reduced in applications where the range of possible dates is known. For example, in an application where the anticipated date range is between Jan. 1, 2000 and Dec. 31, 2000, the dates can be represented by integers in the range of 0 to 365 with Jan. 1, 2000 used as the root date. Therefore, the storage space requirement is 9 bits which is sufficient to represent an integer between 0 to 365. In one embodiment, the root date is not stored with the data proper, and thus, advantageously provides for encryption from a party that has gained access to the data proper representing the date but does not have access to the data rules 310 containing the root date. For example, if the data proper representing a date is 459, the actual date cannot be ascertained unless the party reading the data proper also has access to the root date.

In one embodiment, time values are stored in 11 bits, and represent the minutes that have elapsed since midnight. In another embodiment, time values are represented by the seconds, minutes, or hours that have elapsed since a root time. In one embodiment, the root time is not stored with the data proper, and thus, advantageously provides for encryption from a party that has gained access to the data proper representing the time but does not have access to the data rules 310 containing the root time. For example, if the data proper representing a time is 650, the actual time cannot be ascertained unless the party reading the data proper also has access to the root time.

In one embodiment, list items are stored as list indexes. In this manner, the size of the individual entries are determined by the size of the total list rather than being stored as values. For example, for a list that contains 10 entries, the selection index is stored as a 4-bit value while a selection from a list containing two dozen entries would be stored as a 5-bit value. In one embodiment, the list of possible list values is not stored with the data proper, and thus, advantageously provides for encryption from a party that has gained access to the data proper representing the selection index but does not have access to the data rules 310 containing the list values. For example, if the data proper representing a selection from a list is 12, the actual list selection cannot be ascertained unless the party reading the data proper also has access to the list and the order of items in the list to determine the 12^{th} item on the list.

In one embodiment of the invention, string and text values are stored using a modified EBCDIC (Extended Binary Coded Decimal Interchange Code) or a modified Baudot coding where the resulting encoding requires 5 to 5.3 bits per character of the string. Therefore, the format for storing a string advantageously requires less space to store the characters in a string than conventional coding methods, such as, for example, EBCDIC, Baudot, ASCII, Unicode, and the like. Conventional EBCDIC is a binary code for representing alphabetic and numeric characters. In conventional EBCDIC coding, each alphabetic or numeric character is represented with an 8-bit binary number (i.e. a string of eight 0's or 1's). Therefore, 256 possible characters (letters of the alphabet, numerals, and special characters) are defined. Conventional Baudot code is a five-bit code capable of representing capital letters, numbers, and certain punctuation characters defined as International Telegraph Alphabet #2. Conventional ASCII (American Standard Code for Information Interchange) code is one of the more common formats for text files in computers and on the Internet. Generally, in an ASCII file, each alphabetic, numeric, or special character is represented with a 7-bit binary number (a string of seven 0s or 1s); therefore, 128 possible characters are defined.

In one embodiment, to store string data in a minimal bit-space, four character sets are defined, each consisting of twenty-nine 5-bit characters and three shift characters, which are used to switch between character sets. For example, the first character set consists of the twenty-six characters ‘A’ through ‘Z’ (capitals only) together with three common punctuation characters (i.e., period, comma and space) which are common to all character sets. The remaining entries in the 32-value set are the shift characters used to change to other character sets. A second character set consists of the twenty-six lower-case characters (‘a’ through ‘z’), a third set provides the integers ‘0’ to ‘9’ plus a number of less common punctuation marks, and a fourth set offers addition entries completing the standard ASCII character set plus a few special characters. However, the specific characters used in each set can be varied according to language or other requirements. Moreover, if advantageous, a less compact alphabet set may be employed.

As discussed herein, the tracked entity 140 comprises a person, an object, or a thing, where it is advantageous to maintain historical information about the tracked entity 140. In one embodiment of the invention, the tracked entity 140 comprises a cow. The data tag 120 is encased in a plastic housing, or other flexible protective material, to protect the data tag 120 from damage due to weather conditions or movement of the cow. The data tag 120 is attached to the cow, for example, attached to the cow's ear, and remains with the cow throughout the cow's life. The information regarding the cow is maintained and updated by the field control device 110. The data 320 comprises information such as, for example, the cow's unique animal identification, the cow's country code, the cow's ranch identification, and the like.

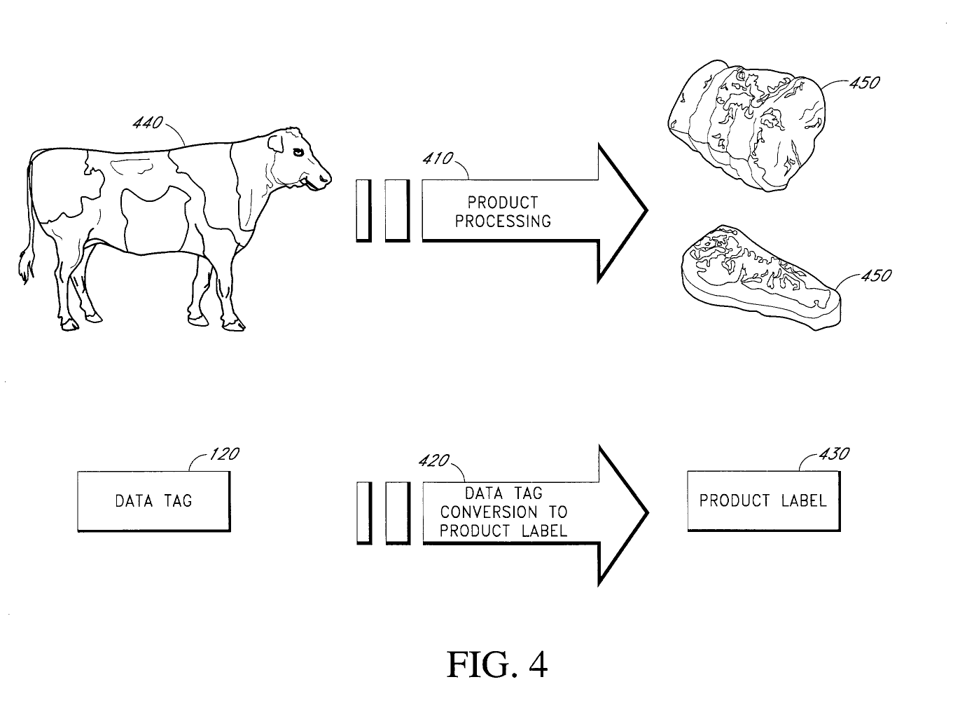

FIG. 4 illustrates a process diagram of data tag conversion during product processing 400, according to aspects of a particular embodiment of the invention. FIG. 4 illustrates the particular embodiment of the invention where the tracked entity 140 comprises a cow 440 associated with the data tag 120. The cow 440 is subjected to product processing 410 which converts the cow 440 to one or more processed beef products 450. In one embodiment, the product processing 410 is performed by a meat packer, or the like. About the time the cow 440 is processed by the meat packer, a data tag conversion to product label process 420 converts the data tag 120 associated with the cow 440 to one or more product labels 430 associated with the one or more processed beef products 450 from the cow 440.

In one embodiment, the data tag conversion to product label process 420 comprises any process where a portion of the information on the data tag 120 is placed on another form of identification. In one embodiment, the data 320 is read from the data tag 120 and converted to a fixed form of identification to be attached to each package of beef products 450 containing meat from the cow 440. The fixed form of identification may include various other information not on the data tag 120, such as, for example, information regarding the meat packer, the date and time of the processing, and the like. The product label 430 comprises a form of identification using any system of representing data about a package, such as, for example, a bar code label. A bar code is generally a small image of lines, bars and spaces that is affixed to objects such as retail store items, identification cards, and postal mail to identify a particular product number, person, or location. The code uses a sequence of vertical bars and spaces to represent numbers and other symbols. A bar code reader is used to read the code. The reader uses a laser beam that is sensitive to the reflections from the line and space thickness and variation. The reader translates the reflected light into digital data that is transferred to a computer for immediate action or storage. In one embodiment of the invention, the bar code standard utilized is PDF417 (Portable Data file) which is generally a 2-dimensional type of bar code that can encode up to 1108 bytes of information. Therefore, the bar code, through lines, bars and spaces, represents the data 320 and other data.

By converting the data tag 120 to a bar code label and attaching it to the package of meat, the source of the meat can be advantageously ascertained from the package. For example, if a certain ranch is identified as afflicted with a certain disease, the meat packages from that ranch can be identified by reading the label on the package of meat, since the ranch identification code is stored on the bar code. In this way, if there is a disease outbreak, the affected packages are identified, and less meat is wasted because the unaffected packages can also be identified and not destroyed. As another example, a grocery store may use the information on the bar codes to perform statistical analysis regarding the meat and determine, for example, which ranches provide a higher quality meat product or a more commercially successful meat product.

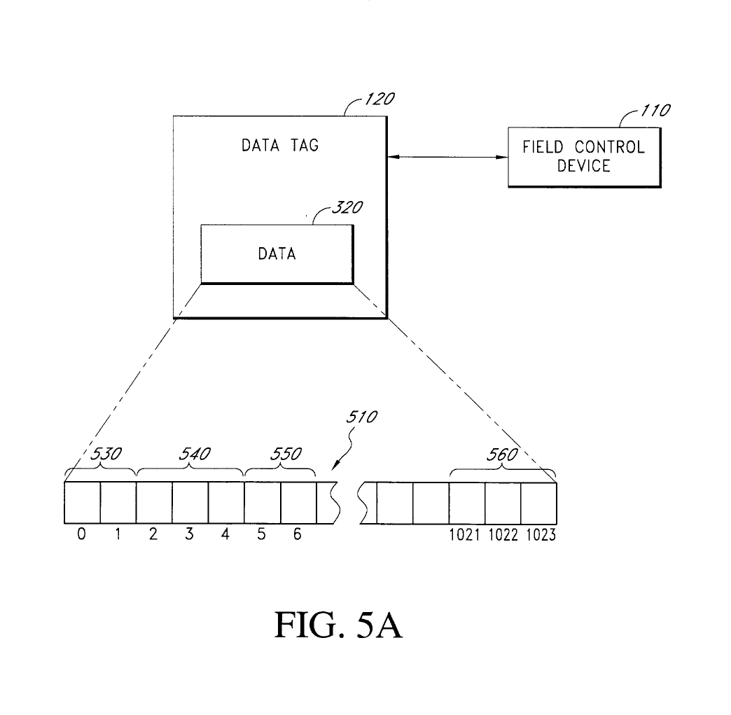

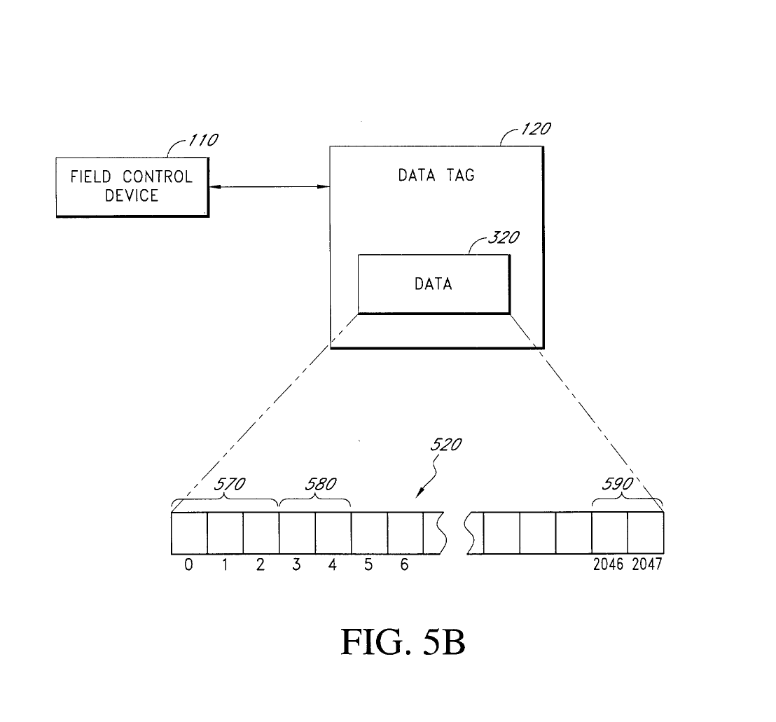

FIGS. 5a and 5b illustrate two exemplary expanded views of data stored on a data tag, according to aspects of two particular embodiment of the invention. As illustrated in FIGS. 5a and 5b, the data 320 comprises a data structure 510 and 520. Each of the data structures 510 and 520 comprises a set of bits. As illustrated, each of the data structures 510 and 520 comprises variable field length encoded fields. For example, the data structure 510 comprises data fields 530, 540, 550, and 560, along with other data fields, stored on a 1024-bit data structure. The data fields 530, 540, 550, and 560 comprise variable-sized number of bits. As illustrated, the data field 530 comprises 2 bits, the data field 540 comprises 3 bits, data field 550 comprises 2 bits, and the data field 560 comprises 3 bits. As another example, the data structure 520 comprises data fields 570, 580, and 590 along with other data fields, stored in a 2048-bit data structure. The data fields 570, 580, and 590 comprise variable numbers of bits. As illustrated, the data field 570 comprises 3 bits, the data field 580 comprises 3 bits, data field 590 comprises 2 bits, and the data field 560 comprises 3 bits.

As illustrated, the data structures 510 and 520 comprise data fields that represent data relating to the tracked entity 140 or represent data relating to other data fields in the data structure. For example, the data field 530 may represent an identification code for the tracked entity 140, or the data field 530 may represent information about another data field in the data structure, such as the data field 540. As an example, one data field may indicate whether another data field contains a positive value or a negative value. As another example, if one data field contains a selected list item, another-data field may represent the list from which the list item is selected. FIGS. 5a and 5b also illustrate the transfer of the data 120 comprising the data structure 510 between the data tag 120 and the field control device 110.

In one embodiment of the invention, the data rules 310 can be used as a decryption key to interpret the data 320 regarding the tracked entity 140. The key can advantageously be provided with the entity so that the data 320 can be interpreted without the use of the field control device 110 and the data server 130. Thus, the key is advantageous in situations where the tracked entity 140 is moved from location to location, or purchased by a party, the data 320 pertaining to the tracked entity 140 can be read and interpreted if the key is provided with the tracked entity 140.

The following appendix describes additional details of specific embodiments of the invention. The appendix is intended to illustrate exemplary embodiments of the invention and is not intended to limit the invention.

While the foregoing detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A distributed database system for tracking historical information about an entity, the distributed database system comprising:
a processing system that includes data rules for processing received data;
a data tag associated with the entity, the data tag storing historical data regarding the entity, the historical data stored on the data tag as variable field length encoded data in a plurality of data fields; and
a communication system for transferring the variable field length encoded data between the processing system and the data tag, the processing system receiving the variable field length encoded data from the data tag and decoding the data to retrieve the historical data encoded on the data tag.

2. The database system of claim 1, wherein the processing system revises the historical data and encodes the revised historical data into variable field length encoded data that is transferred to the data tag on the entity.

3. The database system of claim 1, wherein the data in at least one of the plurality of data fields determines a field length of at least one other of the plurality of data fields.

4. The database system of claim 1, wherein the entity comprises an animal, and wherein the data tag is attached to the animal, the data tag comprising a storage device for storing the variable field length encoded data and a transceiver coupled to the storage device.

5. The database system of claim 4, wherein the communication system includes a transceiver that communicates with the transceiver of the data tag to transfer historical data between the data tag and the processing system.

6. The database system of claim 1, wherein the entity is a product.

7. The database system of claim 6, wherein the product is one of a plurality of products, each product in the plurality of products having a respective data tag so that each product can be distinguished by historical data stored on the respective data tag of the product.

8. A method of tracking historical information about an entity, the method comprising:
storing the historical information as variable field length encoded data on a data tag associated with the entity;
reading the variable field length encoded data and decoding the variable field length encoded data to reproduce the historical data;
updating the historical data to include additional information about the entity; and
storing the updated historical data as variable field length encoded data on the data tag associated with the entity.

9. The method of claim 8, further comprising converting the variable field length encoded data on the tag to a fixed form representation of the historical information for permanent association with at least a portion of the entity.

10. The method claim 9, wherein the entity comprises a cow and wherein portion of the entity comprises a beef product of the cow.

11. The method of claim 9, wherein the fixed form representation of the historical information comprises a label having visible indicia.

12. The method of claim 11, wherein the visible indicia comprises a bar code.

13. The method of claim 11, wherein the visible indicia comprises a two-dimensional bar code.
